(19) United States
(12) Patent Application Publication
(10) Pub. No.: US 2026/0221936 A1
(43) Pub. Date: Jul. 30, 2026

(54) METHOD AND SYSTEM FOR INSPECTING DEVICE

(71) Applicant: HANWHA SOLUTIONS CORPORATION, Seoul (KR)

(72) Inventors: Jang Yong KIM, Seoul (KR); Su Chang LEE, Seou[ (KR); Ju Hwan YUN, Seou[ (KR)

(73) Assignee: HANWHA SOLUTIONS CORPORATION, Seoul (KR)

(21) Appl. No.: 19/157,914

(22) PCT Filed: Mar. 5, 2024
(86) PCT No.: PCT/KR2024/002775

§ 371 Date: Aug. 19, 2025

(30) Foreign Application Priority Data
Mar. 7, 2023 (KR) 10-2023-0030212

(51) Int. Cl. H02S 50/10

(52) U.S. Cl. CPC H02S 50/10

(57) ABSTRACT

A system includes N devices connected to a plurality of solar panels; and an inspector connected to a first device among the N devices and configured to check a state of each of the N devices based on information received from the N devices, wherein, among the N devices, an i-th device is configured to transmit the information to an (i+1)-th device through a first path and transmit the information to an (i−1)-th device through a second path, among the N devices, an N-th device is configured to receive the information from an (N−1)-th device through the first path and transmit the information to the (N−1)-th device through the second path, and the first device is configured to transmit the information to the inspector through the second path.

### TECHNICAL FIELD

The present invention relates to a method and system for inspecting a device.

### BACKGROUND ART

A solar power generation system is a system that converts solar energy into electrical energy by using photovoltaic cells and transmit the electrical energy to a commercial power grid. In the process, no environmental pollution occurs, and the solar power generation system may be used semi-permanently.

In order to monitor the power generation state of a solar panel and increase power generation efficiency, a specific device may be mounted on the solar panel. Therefore, there is a need to inspect the connection state between the solar panel and the device and the operating state of the device.

Conventionally, after an installer installs the device on the solar panel, the connection between the solar panel and the device is inspected by checking whether a light source included in the device is turned on.

In addition, conventionally, after an installer installs the device on the solar panel, the device is connected to a network by directly entering unique information attached to the device into a commissioning system, and the operating state of the device is inspected.

However, conventional methods have problems in that errors are likely to occur during device inspection, inspection time increases, and inconvenience is caused to an installer.

### DISCLOSURE OF INVENTION

### Technical Problem

In order to solve the problems of the prior art as described above, the present invention aims to reduce the possibility of errors occurring during inspection of a device, shorten an inspection time, and provide convenience to an installer.

The technical problems to be solved by the present invention are not limited to the technical problems mentioned above, and other technical problems not mentioned can be clearly understood by one of ordinary skill in the art to which the present invention belongs from the description below.

### Solution to Problem

According to an aspect, a system includes N devices connected to a plurality of solar panels; and an inspector connected to a first device among the N devices and configured to check a state of each of the N devices based on information received from the N devices, wherein, among the N devices, an i-th device is configured to transmit the information to an (i+1)-th device through a first path and transmit the information to an (i−1)-th device through a second path, among the N devices, an N-th device is configured to receive the information from an (N−1)-th device through the first path and transmit the information to the (N−1)-th device through the second path, and the first device is configured to transmit the information to the inspector through the second path, where N is a natural number greater than or equal to 3, and “i” is a natural number greater than or equal to 1 and less than N.

According to another aspect, a method of inspecting N devices connected to a plurality of solar panels includes receiving, by a first device among the N devices, information from an inspector through a first path; transmitting, by the first device, the information to a second device through the first path and transmitting, by the first device, the information to the inspector through a second path; transmitting, by an i-th device among the N devices, the information to an (i+1)-th device through the first path and transmitting, by the i-th device, the information to an (i−1)-th device through the second path; receiving, by an N-th device among the N devices, the information from an (N−1)-th device through the first path and transmitting, by the N-th device, the information to the (N−1)-th device through the second path; and checking, by the inspector, states of the N devices based on information received from the N devices, where N is a natural number greater than or equal to 3, and “i” is a natural number greater than 1 and less than N.

According to still another aspect, a computer-readable recording medium includes a recording medium having recorded thereon a program for causing the method described above to be executed on a computer.

According to a further aspect, an inspector is connected to a first device among N devices connected to a plurality of solar panels and configured to check a state of each of the N devices based on information received from the N devices, wherein, among the N devices, an i-th device is configured to transmit the information to an (i+1)-th device through a first path and transmit the information to an (i−1)-th device through a second path, among the N devices, an N-th device is configured to receive the information from an (N−1)-th device through the first path and transmit the information to the (N−1)-th device through the second path, and the first device is configured to transmit the information to the inspector through the second path, where N is a natural number greater than or equal to 3, and “i” is a natural number greater than or equal to 1 and less than N.

### Advantageous Effects of Invention

According to the present invention, by automatically inspecting at least one of the connection state and the operating state of a device by using a tester, the possibility of errors occurring during device inspection may be reduced, an inspection time may be shortened, and convenience may be provided to an installer.

The effects obtainable from the present invention are not limited to the effects mentioned above, and other effects that have not been mentioned may be clearly understood by one of ordinary skill in the art to which the present invention belongs from the description below.

### BRIEF DESCRIPTION OF DRAWINGS

FIG. 1 is a diagram illustrating an example of a solar power generation system according to an embodiment.

FIG. 2 is a block diagram illustrating an example of an inspector according to an embodiment.

FIG. 3 is a diagram illustrating an example of the operation of a device inspection system, according to an embodiment.

FIG. 4 is a diagram illustrating another example of the operation of a device inspection system, according to an embodiment.

FIG. 5 is a diagram illustrating another example of the operation of a device inspection system, according to an embodiment.

FIG. 6 is a flowchart of an example of a method of inspecting a device, according to an embodiment.

### BEST MODE FOR CARRYING OUT THE INVENTION

According to an aspect, a system includes N devices connected to a plurality of solar panels; and an inspector connected to a first device among the N devices and configured to check a state of each of the N devices based on information received from the N devices, wherein, among the N devices, an i-th device is configured to transmit the information to an (i+1)-th device through a first path and transmit the information to an (i−1)-th device through a second path, among the N devices, an N-th device is configured to receive the information from an (N−1)-th device through the first path and transmit the information to the (N−1)-th device through the second path, and the first device is configured to transmit the information to the inspector through the second path, where N is a natural number greater than or equal to 3, and “i” is a natural number greater than or equal to 1 and less than N.

### Mode for the Invention

The objects, means, and effects of the present invention will become more apparent through the following detailed description with reference to the accompanying drawings, whereby one of ordinary skill in the art to which the present invention belongs will be able to easily implement the technical idea of the present invention. In addition, in the description of the present invention, when it is deemed that certain detailed explanations of known technology related to the present invention may unnecessarily obscure the essence of the present invention, the detailed explanation are omitted.

The terms “or,” “at least one,” etc. used herein may refer to one of the words listed together or may refer to a combination of at least two of the words. For example, “A or B” or “and at least one of A and B” may include only one of A and B or may include both A and B.

Although the terms “first,” “second,” etc. may be used herein to describe various components, but these components should not be limited by these terms. In addition, these terms should not be construed to limit the order of components but may be used to distinguish one component from another.

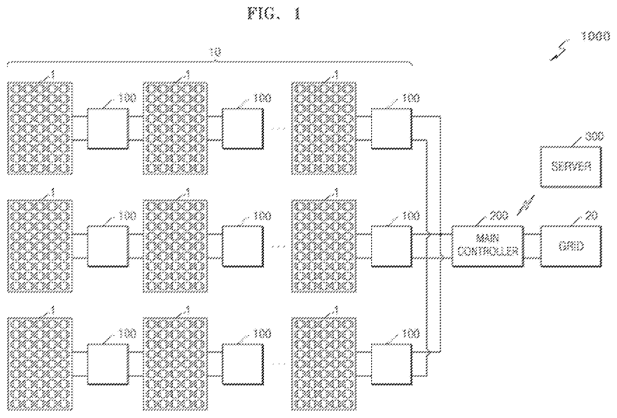

FIG. 1 is a diagram illustrating an example of a solar power generation system according to an embodiment.

Referring to FIG. 1, a solar power generation system 1 may include a string 10, a device 100, and a main controller 200. Additionally, as needed, the system 1 may further include a server 300 and/or a grid 20. In addition to the components illustrated in FIG. 1, other general-purpose components may be further included in the system 1.

The string 10 may be configured by connecting a plurality of solar panels 1 in series to each other through power lines. For example, a plurality of strings 10 may be connected in parallel to each other.

The device 100 may be connected to a solar panel 1. For example, the device 100 may be connected to each solar panel 1, and the number of solar panels 1 may be the same as the number of devices 100 in a string 10.

The device 100 may correspond to module level power electronics (MLPE). For example, the device 100 may be an optimizer or a micro inverter. For example, when the device 100 is an optimizer, the device 100 may regulate power produced from the solar panel 1 and output the power to an inverter (e.g., a string inverter). Current converted (e.g., from direct current to alternating current) by the inverter may be output to a load or the grid 20. For example, when the device 100 is a micro inverter, the device 100 may convert power generated from the solar panel 1. The current converted by the device 100 may be output to a load or the grid 20.

For example, the device 100 may transmit, to the main controller 200, a message for connecting the solar panel 1 to the network. Additionally, the device 100 may transmit power generation information of the solar panel 1 to the main controller 200.

The main controller 200 may perform a rapid shutdown to stop the power generation of the solar panel 1 in an emergency situation. For this operation, the main controller 200 may include a plurality of circuit breakers that block the connection between the string 10 and the grid 20 or the connection between the string 10 and a load. For example, information transmission and reception between the device 100 and the main controller 200 may be performed using a power line communication (PLC) method, but is not limited thereto.

The main controller 200 may collect power generation information received from the plurality of devices 100 and transmit the power generation information to the server 300, and the server 300 may monitor the power generation state of the plurality of solar panels 1 by using the power generation information of the solar panels 1. For example, information transmission and reception between the main controller 200 and the server 300 may be performed using various wired or wireless communication methods.

For example, information transmission and reception between the main controller 200 and the server 300 may be performed using a wireless communication method, such as 5th generation (5G), long term evolution-advanced (LTE-A), LTE, wireless fidelity (Wi-Fi), or Bluetooth, or a wired communication method, such as local area network (LAN), wide area network (WAN), or power line communication.

The main controller 200 may control a device 100 according to the power generation state of a solar panel 1.

In order to monitor the power generation state of the solar panel 1 and control the device 100, it is necessary to inspect the connection state between the solar panel 1 and the device 100 and/or the operating state of the device 100.

Although not shown in FIG. 1, the plurality of devices 100 may be connected to an inspector, and the inspector may check the states of the devices 100 based on information received from the devices 100. Here, the state of each of the devices 100 refers to at least one of the connection state between the solar panel 1 and each device 100 and the operating state of the device 100.

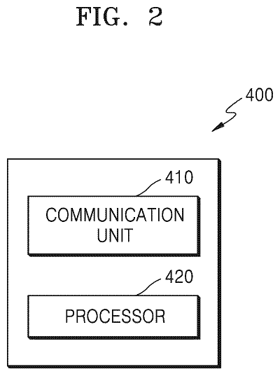

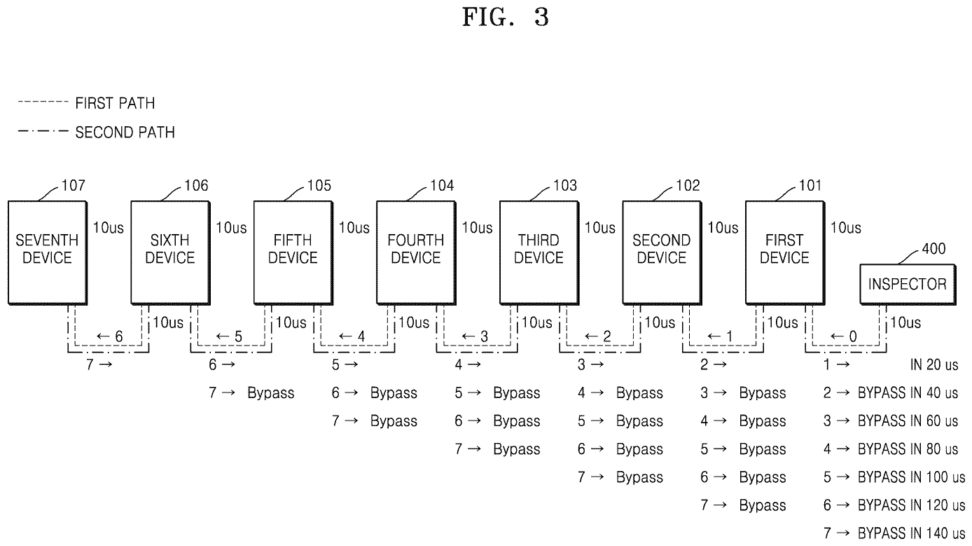

FIG. 2 is a block diagram illustrating an example of an inspector according to an embodiment. FIG. 3 is a diagram illustrating an example of the operation of a device inspection system, according to an embodiment.

FIG. 3 illustrates an example in which the connection state between the solar panel 1 and the device 100 and the operating state of the device 100 are both normal.

Referring to FIGS. 2 and 3, the device inspection system may include an inspector 400 and N devices 100 connected (e.g., in series) to a plurality of solar panels 1. (Here, N is a natural number greater than or equal to 3) The inspector 400 checks the state (e.g., at least one of the connection state and the operating state) of each of the N devices 100. For example, the inspector 400 may be connected to a first device among the devices 100. Assuming that the number of devices 100 is three in total, connection may be like “inspector 400→first device→second device →third device”.

The inspector 400 may include a communication unit 410 and a processor 420. The communication unit 410 may transmit information to the first device among the N devices 100 and may receive information sequentially from the N devices 100.

The processor 420 may process a command of a computer program by performing basic arithmetic, logic, and input/output operations. Here, the command may be provided from an internal memory of the inspector 400 or from an external device. The processor 420 may also generally control operations of other components included in the inspector 400.

The processor 420 may perform at least some of data analysis, processing, and result information generation for performing the above-described operations by using at least one of machine learning, a neural network, or a deep learning algorithm, as a rule-based or artificial intelligence algorithm. Examples of neural networks may include models, such as a convolutional neural network (CNN), a deep neural network (DNN), and a recurrent neural network (RNN).

For example, the processor 420 may be implemented as an array of a number of logic gates or may be implemented as a combination of a general-purpose microprocessor and a memory storing a program that may be executed on the microprocessor. For example, the processor 420 may include a general-purpose processor, a central processing unit (CPU), a microprocessor, a digital signal processor (DSP), a controller, a microcontroller, a state machine, or the like. In some environments, the processor 420 may include an application-specific integrated circuit (ASIC), a programmable logic device (PLD), a field programmable gate array (FPGA), or the like. For example, the processor 420 may refer to a combination of processing devices, such as a combination of a DSP and a microprocessor, a combination of a plurality of microprocessors, a combination of one or more microprocessors in combination with a DSP core, or a combination of any other such components.

The processor 420 may inspect the connection states and/or the operating states of the N devices 100 by checking values or flag values included in the information received from the N devices 100.

Specifically, when the N devices 100 are respectively connected to a plurality of solar panels 1, the inspector 400 obtains information about the number of devices 100 (i.e., N). The inspector 400 sets the values of N flags corresponding to the N devices 100 to 0.

The first device receives information from the inspector 400 through a first path and transmits information to the second device through the first path. Then, the first device transmits information to the inspector 400 through a second path.

In this way, an i-th device among the N devices 100 transmits information to an (i+1)-th device through the first path. Then, the i-th device transmits information to an (i−1)-th device through the second path. (Here, “i” is a natural number greater than 1 and less than N)

Among the N devices 100, an N-th device receives information from an (N−1)-th device through the first path. Then, the N-th device transmits information to the (N−1)-th device based on the second path.

Here, the first path is a path through which information is transmitted from the inspector 400 to the N-th device, and the second path is a path through which information is transmitted from the N-th device to the inspector 400.

The first device adds 1 to a value included in information received through the first path, thereby updating the received information. Then, the first device transmits updated information to the second device through the first path. Then, the first device transmits the updated information to the inspector 400 through the second path.

Additionally, when information is received through the second path, the first device bypasses the received information to the inspector 400.

In this way, the i-th device adds 1 to a value included in information received through the first path, thereby updating the received information. Then, the i-th device transmits the updated information to the (i+1)-th device through the first path. Then, the i-th device transmits the updated information to the (i−1)-th device through the second path.

Additionally, when information is received via the second path, the i-th device bypasses the received information to the (i−1)-th device.

The N-th device adds 1 to a value included in information received through the first path, thereby updating the received information. Then, the N-th device transmits the updated information to the (N−1)-th device through the second path.

When information is received through the second path in a reference time T, the inspector 400 changes a value of a flag corresponding to the first device from 0 to 1. In some embodiments, when information is received through the second path in i*T, the inspector 400 changes a value of a flag corresponding to the i-th device from 0 to 1. In this manner, when information is received through the second path in NT, the inspector 400 changes a value of a flag corresponding to the N-th device from 0 to 1.

Accordingly, the inspector 400 may check the connection states and/or the operating states of the N devices 100 based on the values of flags respectively corresponding to the N devices 100.

A process of transmitting and receiving information between the N-th device and the inspector 400 is described below using an example in which the information is 4-bit data. However, the information is not necessarily limited to 4-bit data, and the size of information may increase or decrease according to the number of devices 100.

When information is 4-bit data, decimal numbers respectively corresponding to 0 to 15 may be expressed as binary numbers [0000], [0001], [0010], [0011], [0100], . . . , [1111], respectively. Here, the values included in the information represent decimal numbers.

Referring to FIG. 3, a first device 101 receives information [0000] from the inspector 400 through the first path. The first device 101 updates the information [0000] to information [0001] by adding 1 to a value “0” included in the received information. The first device 101 transmits the information [0001] to a second device 102 through the first path. The first device 101 transmits the information [0001] to the inspector 400 through the second path.

The inspector 400 check the value (i.e., 1) included in the information received from the first device 101 and changes a value of a flag corresponding to the first device 101 from 0 to 1.

The second device 102 receives the information [0001] from the first device 101 through the first path. The second device 102 updates the information [0001] to information [0010] by adding 1 to a value “1” included in the received information. The second device 102 transmits the information [0010] to a third device 103 through the first path. The second device 102 also transmits the information [0010] to the first device 101 through the second path.

At this time, the first device 101 bypasses the information [0010] received from the second device 102 to the inspector 400. Accordingly, the inspector 400 checks a value (i.e., 2) included in the received information and changes a value of a flag corresponding to the second device 102 from 0 to 1.

This process is repeated up to a seventh device 107. When the operating states and the connection states of all seven devices (i.e., 101 to 107) are normal, the values of the flags respectively corresponding to the seven devices (101 to 107) are all changed to 1.

Information sequentially transmitted by the N devices 100 is received by the inspector 400 at intervals of the reference time T through the second path. Therefore, a maximum inspection time for the N devices 100 is N*T.

For example, referring to FIG. 3, it is assumed that a communication delay time between the first device 101 and the inspector 400 and a communication delay time between the seven devices (101 to 107) are both 10 μs. In this case, when 20 μs elapse since the inspector 400 transmits the information [0000] to the first device 101, the inspector 400 receives the information [0001] from the first device 101. Then, the inspector 400 checks the value (i.e., 1) included in the received information and changes the value of the flag corresponding to the first device 101 from 0 to 1.

When 20 μs elapse from the time when the inspector 400 receives the information from the first device 101, the inspector 400 receives the information [0010] from the second device 102. That is, when 40 us elapse from the time when the inspector 400 transmits the information [0000] to the first device 101, the inspector 400 receives the information [0010] from the second device 102. Then, the inspector 400 checks the value (i.e., 2) included in the received information and changes the value of the flag corresponding to the second device 102 from 0 to 1.

This process is repeated up to the seventh device 107. When 140 us elapse from the time when the inspector 400 transmits the information [0000] to the first device 101, the inspector 400 receives information [1000] from the seventh device 107.

At this time, the reference time T is 20 μs and the maximum inspection time (NT) is 140 μs. However, the reference time T is not limited to 20 μs and may be set in various ways according to a communication environment or a communication delay time between the inspector 400 and the device 101.

In this way, the inspector 400 may check the connection states or the operating states of the N devices 100 by checking the values included in the information received at intervals of the reference time T or by checking the values of flags respectively corresponding to the N devices 100.

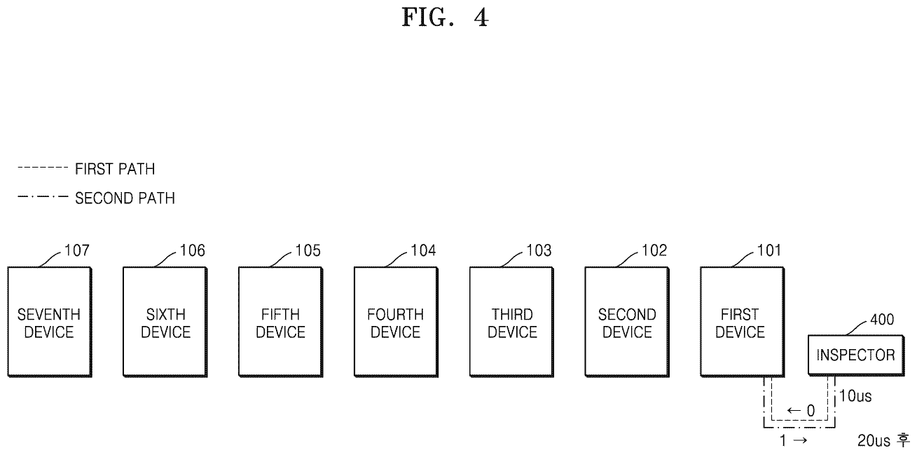

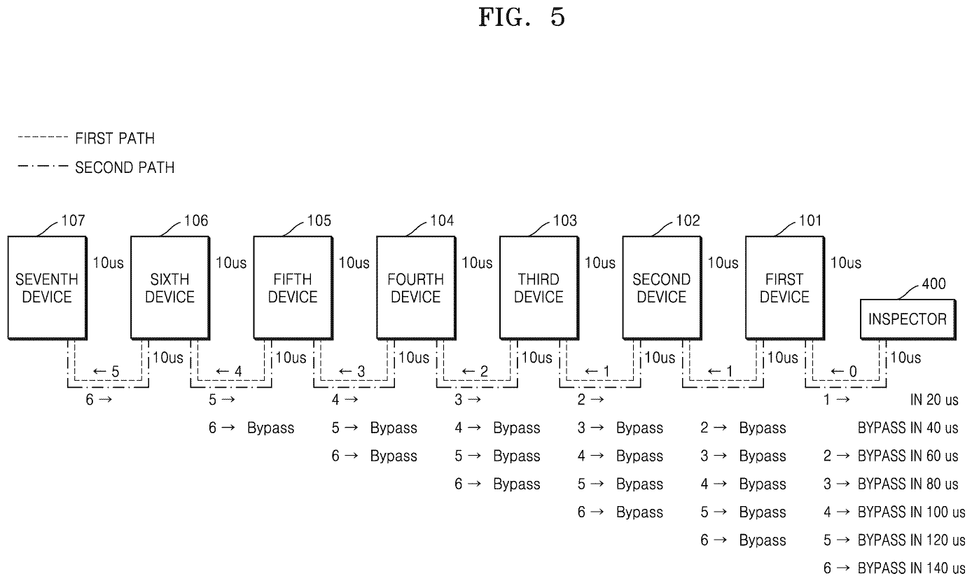

FIG. 4 is a diagram illustrating another example of the operation of a device inspection system, according to an embodiment. FIG. 5 is a diagram illustrating another example of the operation of a device inspection system, according to an embodiment.

FIG. 4 illustrates an example of a poor connection between a solar panel 1 and a device 100. FIG. 5 illustrates an example of a defective operating state of the device 100.

As described above with reference to FIGS. 2 and 3, the connection state or the operating state of the (i−1)-th device is checked based on a value included in information received by the inspector 400 after i*T elapses. In some embodiments, the connection state or the operating state of the i-th device is checked based on a value included in information received by the inspector 400 after (i+1)*T elapses.

For example, referring to FIG. 4, the first device 101 updates the received information by adding 1 to a value included in the information received from the inspector 400 through the first path. Then, the first device 101 transmits the updated information to the second device 102 through the first path. The first device 101 also transmits the updated information to the inspector 400 through the second path.

For example, it is assumed that a communication delay time between the first device 101 and the inspector 400 and a communication delay time between the seven devices (101 to 107) are both 10 μs. In this case, when 20 μs elapse since the inspector 400 transmits the information [0000] to the first device 101, the inspector 400 receives the information [0001] from the first device 101. Then, the inspector 400 checks a value (i.e., 1) included in the received information and changes a value of a flag corresponding to the first device 101 from 0 to 1.

As described above with reference to FIG. 3, when the connection states and the operating states of the seven devices (101 to 107) are all normal, the inspector 400 sequentially receives information from the seven devices (101 to 107) every 20 μs, which is the reference time T. Then, the inspector 400 changes the values of the flags respectively corresponding to the seven devices (101 to 107) from 0 to 1.

When the connection state or the operating state of the second device 102 is defective, the inspector 400 does not receive the information [0010] from the second device 102 when 40 μs elapse from the time when the information [0000] is transmitted to the first device 101. Therefore, the inspector 400 maintains the value of the flag corresponding to the second device 102 as 0.

As illustrated in FIG. 4, when the inspector 400 does not receive information [0011] from the third device 103 even after 60 μs elapse from the time when the inspector 400 transmits the information [0000] to the first device 101, the inspector 400 may determine that the connection state of the second device 102 is defective. That is, when the connection state of the second device 102 is defective, the third device 103 does not receive the information [0010] from the second device 102. Accordingly, the third device 103 may not transmit the information [0011] to the inspector 400.

Similarly, the fourth to seventh devices 104 to 107 may not transmit information to the inspector 400.

In this way, when the inspector 400 does not receive information from the (i−1)-th device or when the value of a flag corresponding to the (i−1)-th device is 0, the inspector 400 may determine that the connection state of the (i−1)-th device is defective. In some embodiments, when the inspector 400 does not receive information from the i-th device when i. T elapses or when the value of a flag corresponding to the i-th device is 0, the inspector 400 may determine that the connection state of the (i−1)-th device is defective.

In some embodiments, when the inspector 400 does not receive information from the i-th device or when the value of a flag corresponding to the i-th device is 0, the inspector 400 may determine that the connection state of the i-th device is defective. In some embodiments, when the inspector 400 does not receive information from the (i+1)-th device when (i+1)*T elapses or when the value of a flag corresponding to the (i+1)-th device is 0, the inspector 400 may determine that the connection state of the (i+1)-th device is defective.

Referring to FIG. 5, the first device 101 updates received information by adding 1 to a value included in the information received from the inspector 400 through the first path. Then, the first device 101 transmits the updated information to the second device 102 through the first path. The first device 101 also transmits the updated information to the inspector 400 through the second path.

For example, it is assumed that a communication delay time between the first device 101 and the inspector 400 and a communication delay time between the seven devices (101 to 107) are both 10 μs. In this case, when 20 μs elapse since the inspector 400 transmits the information [0000] to the first device 101, the inspector 400 receives the information [0001] from the first device 101. Then, the inspector 400 checks a value (i.e., 1) included in the received information and changes the value of a flag corresponding to the first device 101 from 0 to 1.

When the connection state or the operating state of the second device 102 is defective, the inspector 400 does not receive the information [0010] from the second device 102 even after 40 us elapse from the time when the information [0000] is transmitted to the first device 101. Therefore, the inspector 400 maintains the value of a flag corresponding to the second device 102 as 0.

As illustrated in FIG. 5, when the inspector 400 receives the information [0010] from the third device 103 after 60 μs elapse from the time when the inspector 400 transmits the information [0000] to the first device 101, the inspector 400 may determine that the operating state of the second device 102 is defective. That is, even when the operating state of the second device 102 is defective, when the connection state is normal, the third device 103 receives the information [0001] from the second device 102. In some embodiments, the third device 103 transmits the information [0011] to the second device 102, and the second device 102 and the first device 101 bypass the information [0011] to the inspector 400. Accordingly, after 60 μs elapse from the time when the inspector 400 transmits the information [0000] to the first device 101, the inspector 400 receives the information [0010] and changes the value of a flag corresponding to the third device 103 from 0 to 1.

Similarly, the third to seventh devices 103 to 107 transmit information to the inspector 400, and the inspector 400 checks values, which are included in the received information, and changes the values of the flags respectively corresponding to the third to seventh devices 103 to 107 from 0 to 1.

In this way, when the inspector 400 does not receive information from the (i−1)-th device or when the value of a flag corresponding to the (i−1)-th device is 0, the inspector 400 may determine that the operating state of the (i−1)-th device is defective. In some embodiments, when the inspector 400 receives information from the i-th device when i*T elapses or when the value of a flag corresponding to the i-th device is 1, the inspector 400 may determine that the operating state of the (i−1)-th device is defective.

In some embodiments, when the inspector 400 does not receive information from the i-th device or the value of the flag corresponding to the i-th device is 0 and when the inspector 400 receives information from the (i+1)-th device when (i+1)*T elapses or the value of the flag corresponding to the i-th device is 1, the operating state of the i-th device may be determined to be defective.

As described above, according to the device inspection system, the connection state and the operating state of the device 100 may be automatically inspected by the inspector 400. Accordingly, the possibility of errors occurring during inspection of the device 100 is reduced, an inspection time is shortened, and convenience may be provided to an installer.

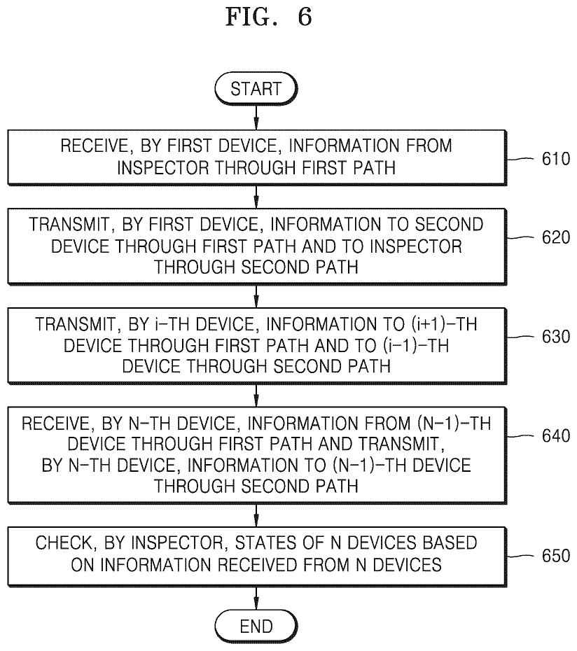

FIG. 6 is a flowchart of an example of a method of inspecting a device, according to an embodiment.

The method illustrated in FIG. 6 includes operations performed time-sequentially by the device inspection system illustrated in FIGS. 2 to 5. Therefore, even if the content is omitted below, the content described above regarding the device inspection system may also be applied to the method illustrated in FIG. 6.

The device inspection method illustrated in FIG. 6 is a method of inspecting the N devices 100 connected to a plurality of solar panels 1. (Here, N is a natural number greater than or equal to 3) First, when the N devices 100 are respectively connected to the solar panels 1, the inspector 400 obtains information about the number of devices 100 (i.e., N). The inspector 400 sets the values of N flags respectively corresponding to the N devices 100 to 0.

A first device receives information from the inspector 400 through a first path in operation 610. That is, the inspector 400 transmits the information to the first device.

Subsequently, the N devices 100 transmit information to the inspector 400.

The first device transmits information to a second device through the first path and transmits the information to the inspector 400 through a second path in operation 620.

Specifically, the first device receives the information through the first path and updates the information by adding 1 to a value included in the received information. Then, the first device transmits the updated information to the second device through the first path. The first device also transmits the updated information to the inspector 400 through the second path.

In some embodiments, when information is received through the second path, the first device bypasses the received information to the inspector 400.

Subsequently, an i-th device among the N devices 100 transmits information to an (i+1)-th device through the first path and transmits the information to the (i−1)-th device through the second path in operation 630. (Here, “i” is a natural number greater than 1 and less than N)

Here, the information is received by the inspector 400 through the second path at intervals of the reference time T, and a maximum inspection time for the N devices 100 is N*T.

In some embodiments, the i-th device receives information through the first path and updates the information by adding 1 to a value included in the information. Then, the i-th device transmits the updated information to the (i+1)-th device through the first path. The i-th device also transmits the updated information to the (i−1)-th device through the second path.

In some embodiments, when information is received through the second path, the i-th device bypasses the received information to the (i−1)-th device.

Subsequently, an N-th device receives information from an (N−1)-th device through the first path and transmits information to the (N−1)-th device through the second path in operation 640.

Here, the N-th device receives information through the first path and updates the information by adding 1 to a value included in the information. Then, the N-th device transmits the updated information to the (N−1)-th device through the second path.

When information is received through the second path in the reference time T, the inspector 400 changes the value of the flag corresponding to the first device from 0 to 1. In some embodiments, when information is received through the second path in i*T, the inspector 400 changes the value of the flag corresponding to the i-th device from 0 to 1. In some embodiments, when information is received through the second path in NT, the inspector 400 changes the value of the flag corresponding to the N-th device from 0 to 1.

Subsequently, the inspector 400 checks the states of the N devices 100 based on the information received from the N devices 100 at intervals of a reference time in operation 650. Specifically, the inspector 400 checks the connection states or the operating states of the N devices 100, based on the values included in the information or the values of flags respectively corresponding to the N devices 100.

Here, the connection state or the operating state of the (i−1)-th device may be checked based on the value included in the information received by the inspector 400 after i*T elapses. In some embodiments, the connection state or the operating state of the i-th device may be checked based on the value included in the information received by the inspector 400 after (i+1)*T elapses.

As described above, according to the device inspection method, the connection state and the operating state of a device 100 may be automatically inspected by the inspector 400. Accordingly, the possibility of errors occurring during inspection of the device 100 is reduced, an inspection time is shortened, and convenience may be provided to an installer.

The above-described method may be written as a program that may be executed on a computer and implemented on a general-purpose digital computer that runs the program by using a computer-readable recording medium. In addition, the structure of data used in the above-described method may be recorded on a computer-readable recording medium through various means. The computer-readable recording medium includes a storage medium, such as a magnetic storage medium (e.g., ROM, RAM, USB, floppy disk, hard disk, etc.) or an optical readable medium (e.g., CD-ROM, DVD, etc.).

It will be understood by one of ordinary skill in the art related to the present embodiments that various changes may be made without departing from the fundamental characteristics of the disclosure described above. Therefore, the disclosed methods should be considered in descriptive sense only and are not for purposes of limitation. It should be construed that the scope of the claims is defined not by the descriptions above but by the appended claims and includes all differences falling within the scope equivalent thereto.

1. A system comprising:
N devices connected to a plurality of solar panels; and
an inspector connected to a first device among the N devices and configured to check a state of each of the N devices based on information received from the N devices,
wherein, among the N devices, an i-th device is configured to transmit the information to an (i+1)-th device through a first path and transmit the information to an (i−1)-th device through a second path,
among the N devices, an N-th device is configured to receive the information from an (N−1)-th device through the first path and transmit the information to the (N−1)-th device through the second path, and
the first device is configured to transmit the information to the inspector through the second path,
where N is a natural number greater than or equal to 3, and “i” is a natural number greater than or equal to 1 and less than N.

2. The system of claim 1, wherein
the first path includes a path through which the information is
transmitted from the inspector to the N-th device, and
the second path includes a path through which the information is transmitted from the N-th device to the inspector.

3. The system of claim 2, wherein
the i-th device is further configured to
update information received through the first path by adding 1 to a value included in the received information, transmit the updated information to the (i+1)-th device through the first path,
transmit the updated information to the (i−1)-th device through the second path, and
bypass information received through the second path to the (i−1)-the device.

4. The system of claim 3, wherein
the first device is further configured to
update information received through the first path by adding 1 to a value included in the received information,
transmit the updated information to a second device through the first path,
transmit the updated information to the inspector through the second path, and
bypass information received through the second path to the inspector.

5. The system of claim 4, wherein
the N-th device is further configured to
update the information received through the first path by adding 1 to a value included in the received information and
transmit the updated information to the (N−1)-th device through the second path.

6. The system of claim 5, wherein
the information is received by the inspector at intervals of a reference time of T through the second path, and
a maximum inspection time for the N devices includes N*T.

7. The system of claim 6, wherein
the inspector is further configured to
check at least one of a connection state and an operating state of each of the N devices by checking a value included in the information received at intervals of the reference time.

8. The system of claim 6, wherein
the inspector is further configured to check at least one of a connection state and an operating state of the (i−1)-th device based on a value included in the information received after i*T elapses and
check at least one of a connection state and an operating state of the i-th device based on a value included in the information received after (i+1)*T elapses.

9. The system of claim 6, wherein
the inspector is further configured to
set N flags respectively corresponding to the N devices to 0.

10. The system of claim 9, wherein
the inspector is further configured to
change a value of the flag corresponding to the first device from 0 to 1 when the information is received through the second path in the reference time of T,
change a value of the flag corresponding to the i-th device from 0 to 1 when the information is received through the second path in i*T, and
change a value of the flag corresponding to the N-th device from 0 to 1 when the information is received through the second path in N*T.

11. The system of claim 10, wherein
the inspector is further configured to
check at least one of a connection state and an operating state of each of the N devices based on a value of each of the flags respectively corresponding to the N devices.

12. A method of inspecting N devices connected to a plurality of solar panels, the method comprising:
receiving, by a first device among the N devices, information from an inspector through a first path;
transmitting, by the first device, the information to a second device through the first path and transmitting, by the first device, the information to the inspector through a second path;
transmitting, by an i-th device among the N devices, the information to an (i+1)-th device through the first path and transmitting, by the i-th device, the information to an (i−1)-th device through the second path;
receiving, by an N-th device among the N devices, the information from an (N−1)-th device through the first path and transmitting, by the N-th device, the information to the (N−1)-th device through the second path; and
checking, by the inspector, states of the N devices based on information received from the N devices,
where N is a natural number greater than or equal to 3, and “i” is a natural number greater than 1 and less than N.

13. The method of claim 12, wherein
the information is received by the inspector at intervals of a reference time of T through the second path, and
a maximum inspection time for the N devices includes N*T.

14. The method of claim 13, wherein
the checking includes
checking at least one of a connection state and an operating state of each of the N devices by checking a value included in the information received at intervals of the reference time.

15. The method of claim 14, wherein
the checking includes:
checking at least one of the connection state and the operating state of the (i−1)-th device based on a value included in the information received after i*T elapses; and
checking at least one of the connection state and the operating state of the i-th device based on a value included in the information received after (i+1)*T elapses.

16. The method of claim 13, further comprising setting, by the inspector, N flags corresponding to the N devices to 0.

17. The method of claim 16, further comprising:
changing, by the inspector, a value of the flag corresponding to the first device from 0 to 1 when the information is received through the second path in the reference time of T;
changing, by the inspector, a value of the flag corresponding to the i-th device from 0 to 1 when the information is received through the second path in i*T; and
changing, by the inspector, a value of the flag corresponding to the N-th device from 0 to 1 when the information is received through the second path in N*T.

18. The method of claim 17, wherein
the checking includes
checking at least one of a connection state and an operating state of each of the N devices based on a value of the flag corresponding to each of the N devices.

19. A computer-readable recording medium having recorded thereon
a program for causing the method of claim 12 to be executed on a computer.
